(19) United States
(12) Patent Application Publication
(10) Pub. No.: US 2024/0369866 A1
(43) Pub. Date: Nov. 7, 2024

(54) Electro-optic Modulator Device, Method, and Applications

(71) Applicant: Xuan Sun, Rochester, NY (US)

(72) Inventor: Xuan Sun, Rochester, NY (US)

(21) Appl. No.: 18/624,383

(22) Filed: Apr. 2, 2024

Related U.S. Application Data
(60) Provisional application No. 63/464,211, filed on May 5, 2023.

(51) Int. Cl. G02F 1/035

(52) U.S. Cl. CPC G02F 1/035

(57) ABSTRACT

An electro-optic modulator device and associated method utilizes a frequency down conversion process, in which a lower frequency output signal has a relatively higher modulation efficiency similar to the higher modulation efficiency of a modulated higher frequency input signal.

### RELATED APPLICATION DATA

The instant application claims priority to U.S. provisional Application No. 63/464,211 filed May 5, 2023, the subject matter of which is incorporated herein by reference in its entirety.

### GOVERNMENT FUNDING

Funding for the instant invention was provided by the U.S. Department of Energy under contract #DE-SC0022798. The U. S. government has certain rights in the invention.

### BACKGROUND

Aspects and embodiments described herein most generally pertain to the field of electro-optic (EO) modulation, associated methods, and applications; more specifically to devices and methods for modulating the output of laser transmitters; and most specifically to efficient, high speed EO modulator (EOM) devices, methods for efficient, high speed EO modulation, and applications.

High-speed modulation of laser frequency and/or intensity is important for many applications such as data communication, sensing, augmented/virtual reality, among many others. Lithium niobate (LN) is ideally suited for this purpose since it exhibits an electro-optic Pockels effect with an extremely fast response time and has been widely employed for high-speed electro-optic modulation. However, the modulation efficiency is fairly limited in the telecom band where a majority of applications lie; for example, for optical data communication LN-based electro-optic modulators (EOMs) have a lower modulation efficiency compared with silicon- or InP-based EOMs, leading to higher power consumption. This raises a significant concern in data communications since power consumption is a critical factor impacting the operation of data centers. As another example, for frequency-modulated continuous-wave (FMCW) LIDAR (Light Detection and Ranging), the tuning range of the laser frequency directly impacts the ranging resolution. However, the LN-based frequency modulation approach requires relatively high voltage (up to tens of Volts) to achieve a reasonable amount of frequency tuning, which makes it challenging to implement in practice. The limited modulation efficiency imposes serious challenges for practical applications. The inventor has recognized that devices and methods enabling highly efficient electro-optic modulation, particularly in the telecom-band and mid infrared spectral regions, as described herein below and in the appended claims would be advantageous and beneficial for many applications, and solve many of the problems recognized in the art.

### SUMMARY

An aspect of the invention is an electro-optical (EO) modulator device (EOM). In a non-limiting embodiment, the EOM includes a device platform adapted to functionally support at least one of the following components: an input propagation path for a first laser at frequency, ω₁; an input propagation path for a second laser at frequency, ω₂; an electro-optic modulator (EOM) adapted to modulate the wave at ω₁ via an input control signal; a wavelength division multiplexer (WDM MUX) adapted to combine the two optical waves at ω₁ and ω₂; a difference frequency generator (DFG) adapted to down-convert the combined waves at ω₁ and ω₂ to a wave at a third frequency, ωₛ, where ωₛ=|ω₁−ω₂|, further wherein ωₛ is less than ω₂ and ω₁, whereby an output from the device at ωₛ is a modulated signal having a modulation efficiency comparable to a modulation efficiency of the wave at ω₁. In various alternative exemplary, non-limiting embodiments the EOM may further include one or more of the following elements, components, or limitations alone or in various combinations as a PHOSITA would recognize:
further comprising a wavelength division demultiplexer (WDM DEMUX) adapted to separate two launched inputs at ω₁ and ω₂ into the input propagation path for the first laser at frequency, ω₁, and the input propagation path for the second laser at frequency, ω₂, respectively;
wherein the device platform is one of a lithium niobate (LiNbO₃), lithium tantalate (LiTaO₃), potassium niobate (KNbO₃), III-V semiconductors (AlN, GaN, GaP, GaAs, AlGaAs, InP), barium titanate (BaTiO₃), electro-optic polymer, silicon, or a composite medium formed by integrating one of these materials with a dielectric material such as silicon nitride or silicon dioxide;
wherein the EOM is an electro-optic modulator made from the device platform (e.g., a LiNbO₃ electro-optic modulator if the device platform is LiNbO₃);
wherein the DFG is one of a nonlinear waveguide and a nonlinear microresonator, made from the device platform (e.g., a periodic-poled LiNbO₃ (PPLN) waveguide and a PPLN micorresonator if the device platform is LiNbO₃);
further comprising an input laser source for ω₁ and ω₂ integrally disposed on the device platform;
   wherein the input laser source comprises a first laser operating at frequency ω₁ (denoted as Laser 1) formed by an external cavity on the device platform and a III-V gain element, an electro-optically or thermo-optically tunable distributed Bragg reflector (DBR) operating at frequency ω₁, an electro-optic or thermo-optic phase shifter, and a III-V reflective semiconductor optical amplifier (RSOA) having a gain spectrum covering ω₁; and a second laser operating at frequency ω₂ (denoted as Laser 2) formed by an external cavity on the device platform and a III-V gain element, an electro-optically or thermo-optically tunable distributed Bragg reflector (DBR) operating at frequency ω₂, an electro-optic or thermo-optic phase shifter, and a III-V reflective semiconductor optical amplifier (RSOA) having a gain spectrum covering ω₂;
      wherein the DFG device is physically disposed in the laser cavity;
      wherein the EOM is a push-pull phase modulator;
wherein the input laser source is edge-coupled to the device platform;
wherein the input laser source is heterogeneously integrated on a surface of the device platform.

An aspect of the invention is an electro-optic (EO) modulation method. In a non-limiting embodiment, the method includes the steps of providing a first propagating EM wave having a frequency, ω₁; providing a second propagating EM wave having a frequency, ω₂; modulating the EM wave at frequency ω₁; combining the first and second propagating EM waves, employing a difference frequency generation (DFG) process on the combined EM waves to generate a down-converted EM wave at frequency ωₛ=|ω₁−ω₂|, where ωₛ is less than ω₂ and ω₁, whereby a high modulation efficiency at the higher frequency ω₁ is directly transferred to the lower frequency at ωₛ. In various alternative exemplary, non-limiting embodiments the EOM may further include one or more of the following steps, procedures, elements, components, or limitations alone or in various combinations as a PHOSITA would recognize:
further comprising modulating the wave at ω₂;
further comprising modulating the wave at ω₁ with a ramp rate η₁ greater than zero and modulating the wave at ω₂ with an opposite ramp rate 12 less than zero, or vice versa, whereby a ramp rate of the down-converted wave at ωs is the sum of the ramp rates for ω₁ and ω₂, such that |ηₛ=|η₁|+|η₂|.

### BRIEF DESCRIPTION OF THE DRAWINGS

FIG. 1 is a schematic drawing conceptually illustrating related device and method elements, according to a non-limiting, exemplary embodiment.

FIG. 2 is a schematic showing a layout of a high modulation efficiency EOM device with detailed device elements and related functionalities, in which the DFG is a nonlinear waveguide, according to a non-limiting, exemplary embodiment.

FIG. 3 is a schematic illustrating the method and the operation principle. (a) schematic showing the DFG process: (b) schematic showing the temporal waveforms of the two pump lasers and the down-converted laser, according to illustrative embodiments.

FIG. 4 schematically shows a high modulation efficiency EOM device as illustrated in FIG. 2 except that the DFG nonlinear waveguide is replaced with a DFG nonlinear microresonator, according to a non-limiting, exemplary embodiment.

FIG. 5 schematically shows a high modulation efficiency EOM device in the form of a laser transmitter where the two pump lasers are integrated on the same chip, according to a non-limiting, exemplary embodiment. (RSOA: Reflective semiconductor optical amplifier).

FIG. 6 schematically shows a high modulation efficiency EOM device in the form of a laser transmitter where the two pump lasers are integrated on the same chip and the DFG nonlinear waveguide is replaced with a DFG nonlinear microresonator, according to a non-limiting, exemplary embodiment.

FIG. 7 schematically shows a high modulation efficiency EOM device in the form of a laser transmitter where the two pump lasers are integrated on the same chip and the DFG nonlinear waveguide is integrated inside the laser cavity, according to a non-limiting, exemplary embodiment.

FIG. 8 schematically and graphically illustrates the operation principle of frequency modulation: (a) schematic showing the DFG process with laser frequency modulation; (b) temporal waveforms of the modulated laser frequencies for the two pump lasers and for the down-converted laser, according to illustrative embodiments.

FIG. 9 schematically shows a high modulation efficiency EOM device as illustrated in FIG. 7 except that the intracavity DFG nonlinear waveguide is replaced with a DFG nonlinear microresonator, according to a non-limiting, exemplary embodiment.

FIG. 10 schematically shows a high modulation efficiency EOM device where the two lasers are modulated with a push-pull LN modulator, according to a non-limiting, exemplary embodiment.

FIG. 11 schematically shows a high modulation efficiency EOM device as illustrated in FIG. 10 except that the intracavity DFG nonlinear waveguide is replaced with a DFG nonlinear microresonator, according to a non-limiting, exemplary embodiment.

FIG. 12 schematically shows a high modulation efficiency EOM device as illustrated in FIG. 10 but the intracavity DFG nonlinear waveguide is placed outside the laser cavity, according to a non-limiting, exemplary embodiment.

FIG. 13 schematically shows a high modulation efficiency EOM device as illustrated in FIG. 12 except that the DFG nonlinear waveguide is replaced with a DFG nonlinear microresonator, according to a non-limiting, exemplary embodiment.

FIG. 14 schematically shows a high modulation efficiency EOM device where the III-V gain medium is integrated on the top of the LN device structure via heterogeneous integration, according to a non-limiting, exemplary embodiment.

FIG. 15 schematically shows a high modulation efficiency EOM device as illustrated in FIG. 14 except that the intracavity DFG nonlinear waveguide is replaced with a DFG nonlinear microresonator, according to a non-limiting, exemplary embodiment.

FIG. 16 schematically shows a high modulation efficiency EOM device as illustrated in FIG. 14 except that the intracavity DFG nonlinear waveguide is placed outside the laser cavity, according to a non-limiting, exemplary embodiment.

FIG. 17 schematically shows a high modulation efficiency EOM device as illustrated in FIG. 16 except that the DFG nonlinear waveguide is replaced with a DFG nonlinear microresonator, according to a non-limiting, exemplary embodiment.

### DETAILED DESCRIPTION OF NON-LIMITING, EXEMPLARY EMBODIMENTS

Embodiments described hereinbelow and in the appended claims enable a new approach for high-speed electro-optic modulation with high modulation efficiency. The embodied device and method enable particularly advantageous applications in the telecom band but in other spectral bands as well.

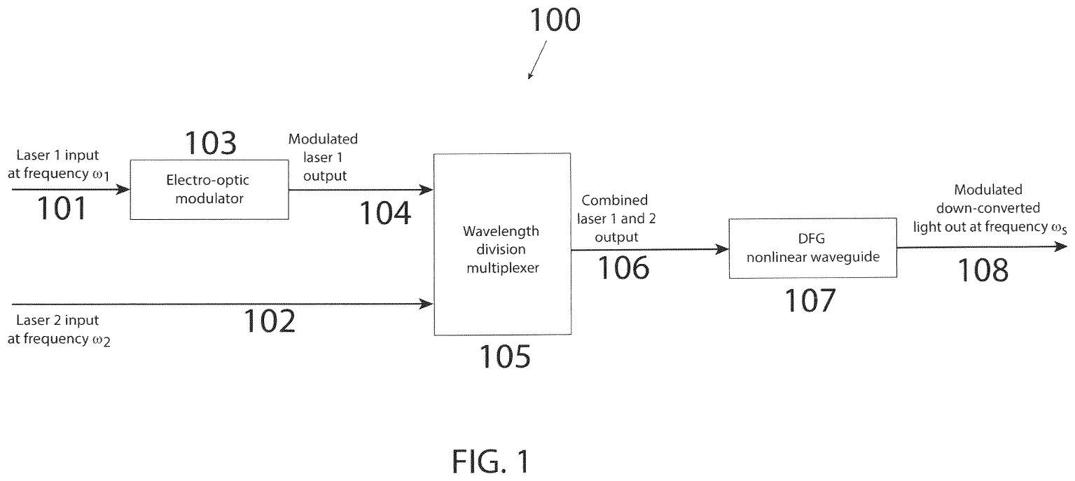

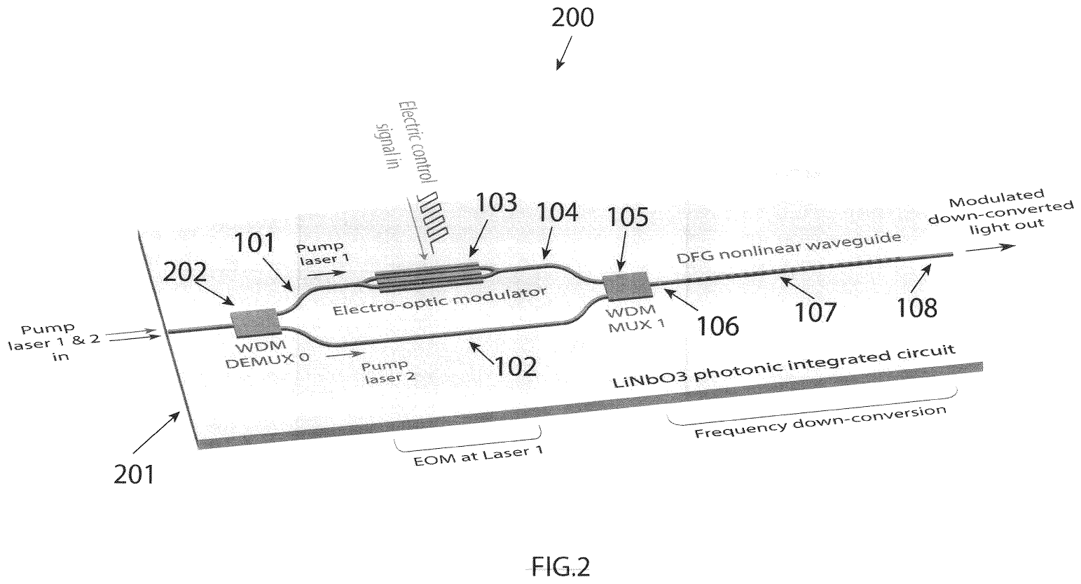

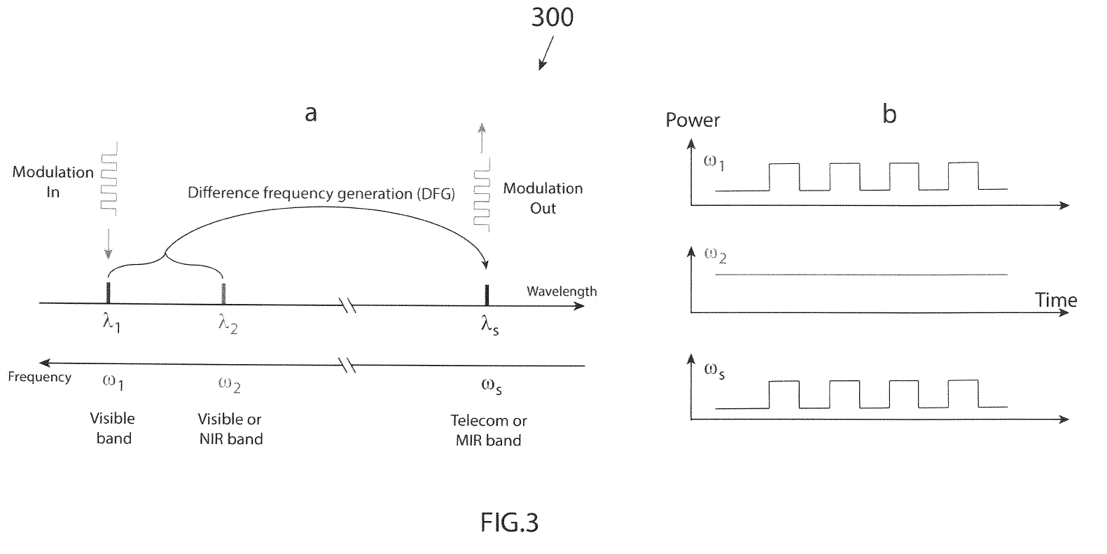

FIG. 1 shows the basic conceptual elements. FIG. 2 shows a non-limiting, exemplary device layout, and FIG. 3 shows an associated operation principle. The embodiments recognize and leverage the fact that the magnitude of the induced phase modulation in an electro-optic phase modulator increases with increased optical frequency, resulting in higher modulation efficiency at shorter optical wavelengths. As such, rather than directly modulating a telecom-band laser, for example, as typical of the current state of the art, we herein describe modulating an optical wave at a high optical frequency, ω₁, (for example, in the visible band), and then combine it with another laser at frequency, ω₂, to down-convert to a telecom-band frequency. ωₛ, via an efficient difference frequency generation (DFG) process, ωₛ=|ω₁−ω₂|, inside a nonlinear optical waveguide. Here, the inherently higher modulation efficiency at the higher optical frequency ω₁ is directly transferred to a lower frequency at ωₛ. An example of the operating wavelength set is λ₁=450 nm, λ₂=634 nm, and λₛ=1550 nm. Other wavelength sets can be used as well.

FIG. 1 schematically shows the conceptual elements of the EOM device 100. Most generally, the EOM device includes an optical waveguide path 101 in which a laser at frequency ω₁ is launched into, a second optical waveguide path 102 into which another laser at frequency ω₂ is launched, an electro-optic modulator 103 implemented in the path 101 for light at ω₁ to modulate the light, a WDM MUX 105 to combine the two laser beams (the modulated light at ω₁ and unmodulated light at ω₂) into one waveguide path 106, and a DFG nonlinear waveguide 107 to down convert the combined light to a frequency ωₛ (output 108), via the difference frequency generation (DFG) process ωₛ=|ω₁−ω₂| where, for example, λ₁=450 nm, λ₂=634 nm, and λₛ=1550 nm, advantageously a telecom band. Other wavelength/frequency values could be used as a PHOSITA would understand.

FIG. 2 schematically shows an EOM device 200 fabricated on a device platform 201 (“chip”) in the form of a, e.g., LiNbO₃ photonic integrated circuit, which could alternatively be composed of lithium tantalate (LiTaO₃), potassium niobate (KNbO₃), III-V semiconductors (AlN, GaN, GaP, GaAs, AlGaAs, InP), barium titanate (BaTiO₃), electro-optic polymer, silicon, or a composite medium formed by integrating one of these materials with a dielectric material such as silicon nitride or silicon dioxide. The EOM device includes a wavelength-division demultiplexer (WDM DEMUX) 202 to separate two laser beams having respective frequencies ω₁ and ω₂ launched onto the chip 201, into two separate propagation paths 101, 102, an electro-optic modulator 103 implemented in the path 101 for light at ω₁ to modulate the light, a WDM MUX 105 to combine the two laser beams (the modulated light at ω₁ and unmodulated light at ω₂) into one waveguide path 106, and a DFG nonlinear waveguide 107 to down convert the combined light to a frequency ωₛ (output 108), via the difference frequency generation (DFG) process ωₛ=|ω₁-ω₂| where, for example, λ₁=450 nm, λ₂=634 nm, and λₛ=1550 nm, advantageously a telecom band. Other wavelength/frequency values could be used as a PHOSITA would understand. For LiNbO₃ device platform, a typical DFG waveguide is a periodic-poled lithium niobate (PPLN) waveguide, but other types of DFG waveguides can be used as well.

FIGS. 3(a, b) schematically and graphically illustrate the embodied process where FIG. 2(a) illustrates the DFG process; and FIG. 2(b) shows the temporal waveforms of the two pump laser inputs at ω₁, ω₂ and the highly efficiently modulated down-converted laser at frequency ωₛ.

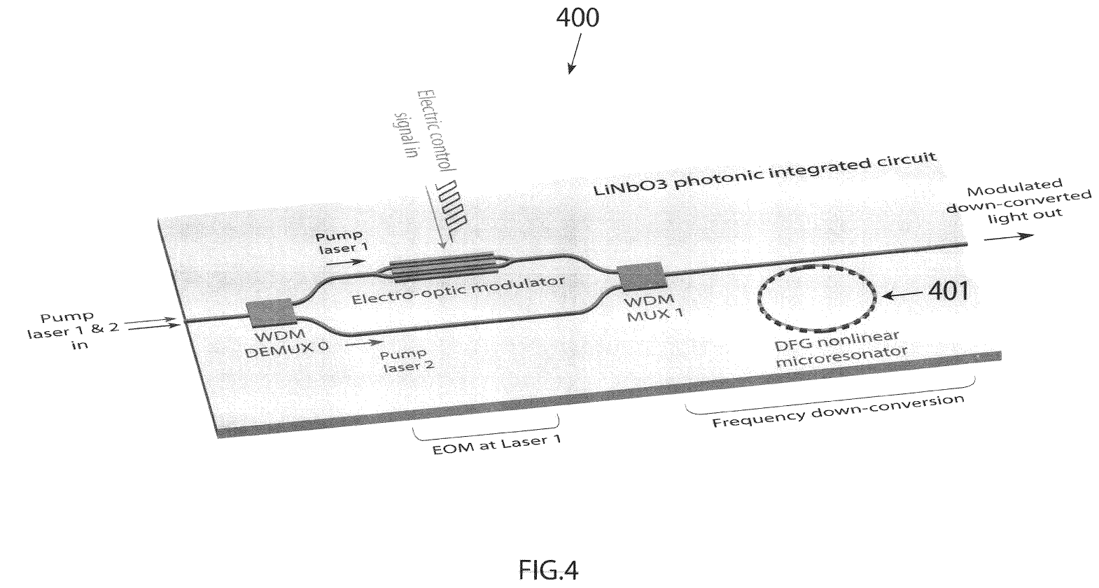

FIG. 4 schematically illustrates another embodiment 400 similar to FIG. 2 except that the DFG waveguide 107 is replaced by a DFG nonlinear microresonator 401.

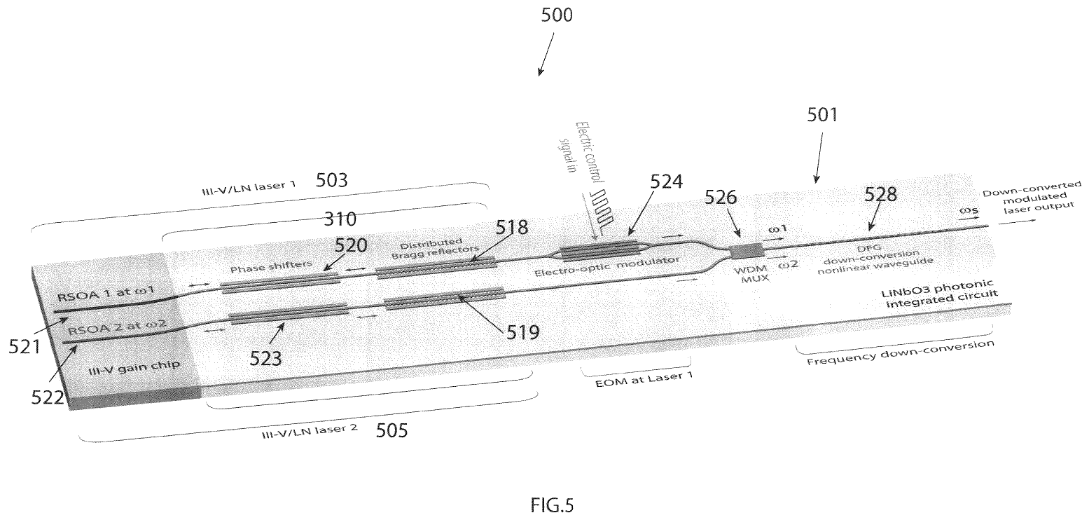

FIG. 5 schematically illustrates another embodiment in the form of a modulated laser transmitter 500 in which two lasers 503, 505 at high optical frequencies ω₁, ω₂, respectively, are provided directly on the same chip 501. The integrated laser 503 (Laser 1) operating at frequency ω₁ is formed by an external cavity 510 on a LN platform 501 integrated with a III-V gain element. The III-V/LN external cavity laser includes a LN distributed Bragg reflector (DBR) 518 operating at frequency ω₁ that is electro-optically or thermo-optically tunable with integrated tuning electrodes, an LN electro-optic or thermo-optic phase shifter 520, and a III-V reflective semiconductor optical amplifier (RSOA) 521 having a gain spectrum covering ω₁. The second integrated laser 505 (Laser 2) operating at frequency ω₂ is similar to that of laser 1 except that the LN DBR 519 and the LN phase shifter 523 are designed to operate at ω₂ and the RSOA 522 has a gain spectrum covering ω₂. The device 500 further includes an electro-optic modulator 524 at the output of laser 1 to perform intensity modulation of the laser, a WDM MUX 526 to combine the two laser beams into one waveguide, and a DFG nonlinear waveguide 528 to down-convert the two laser frequencies to, e.g., the telecom-band frequency ωₛ, via the DFG process ωₛ=|ω₁−ω₂|, where ω₁ and ω₂ are much higher than ωₛ. As embodied, light at lower frequency (longer wavelength) ωₛ is modulated with a modulation efficiency associated with that at higher frequency (shorter wavelength) ω₁, wherein said efficiency is inherently higher at higher frequencies.

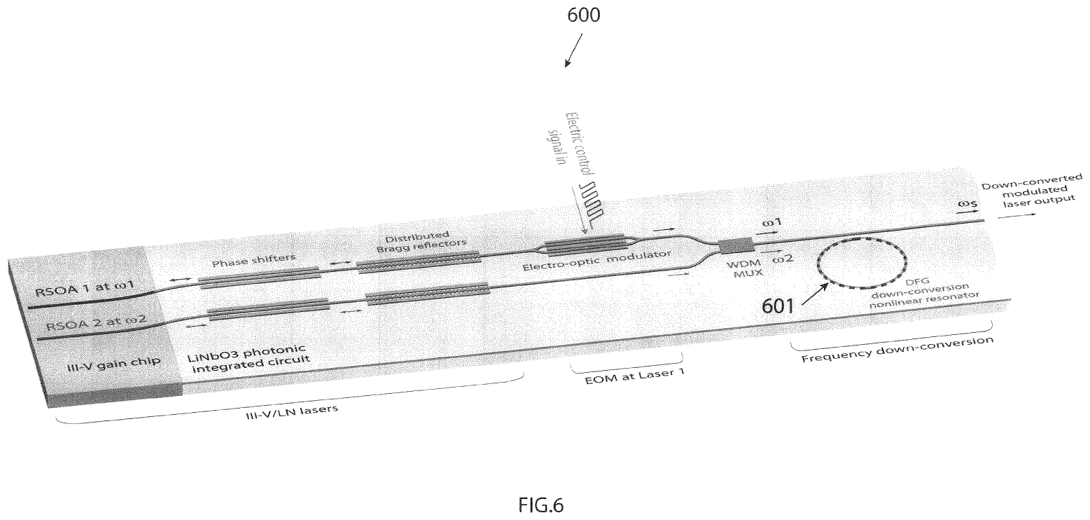

FIG. 6 schematically illustrates another embodiment 600 similar to FIG. 5 except that the DFG waveguide 528 is replaced by a DFG nonlinear microresonator 601.

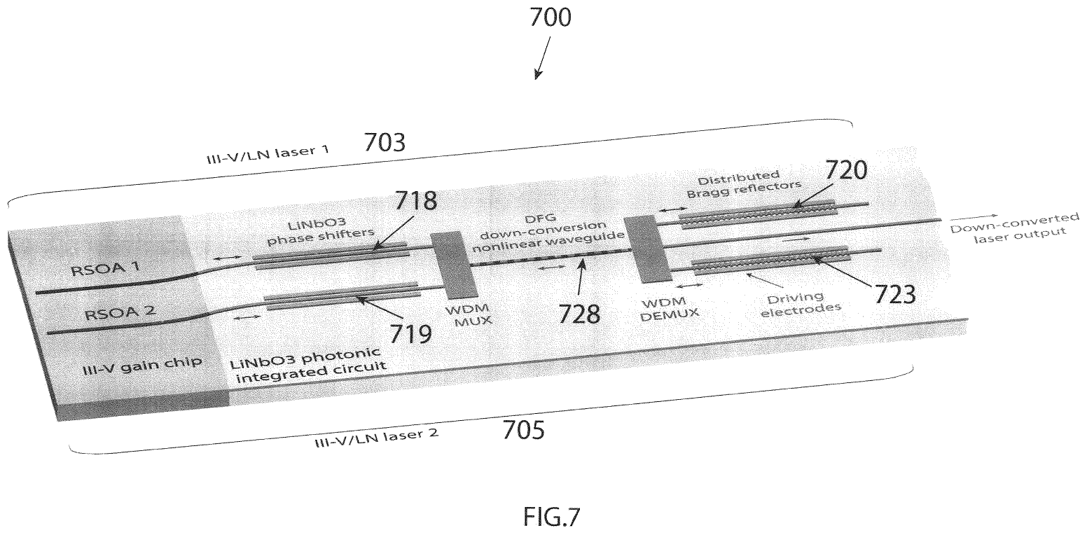

FIG. 7 schematically shows a device 700 for highly efficient frequency modulation of an exemplary telecom-band laser light. The two lasers 703, 705 at frequencies ω₁ and ω₂ are very similar to those described immediately above in reference to FIG. 5, but the DFG nonlinear waveguide 728 is now embedded inside the laser cavity as shown in FIG. 5. This disposition advantageously increases the DFG efficiency by taking advantage of the inherently higher laser power inside the laser cavity. The high-speed frequency modulation of both lasers is realized via high-speed electro-optic tuning of the respective LN DBR and LN phase shifters 720, 723, 718, 719.

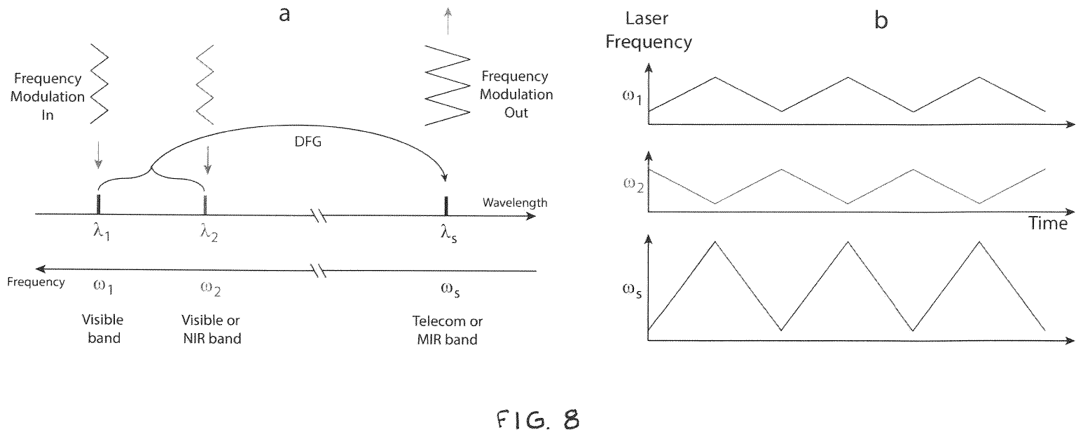

FIGS. 8(a, b) schematically and graphically illustrate the operation principle. FIG. 8a shows the DFG process with laser frequency modulation; FIG. 8b shows the temporal waveforms of the modulated laser frequencies for the two input lasers at ω₁ and ω₂ and for the down-converted laser output at ωₛ. An electric driving waveform (shown as a triangular function but any waveform can be used) applied to the frequency tuning elements of laser 1 will produce a same waveform on the time-dependent laser frequency, for example, ω₁ (δt)=ω₁₀+η₁δₜ. Similarly, that applied to laser 2 will produce a laser frequency waveform of ω₂ (δt)=ω₂₀+η₂δₜ, where η₁ and η₂ are the ramp rates of the two laser frequencies. Consequently, the DFG process produces a down-converted laser with a laser frequency waveform of ωₛ(δt)=ω₁(δt)−ω₂(δt)=(ω₁₀−ω₂₀)+(η₁−η₂) δt≡ωₛₒ+ηₛδt, where ηₛ=η₁−η₂ is the frequency ramp rate of the down-converted laser. If the two lasers are modulated with opposite ramp rates (η₁>0 and η₂<0, or vice versa), the ramp rate of the down-converted laser will be the sum of those for the two pump lasers, |ηₛ|=|η₁|+|η₂|, demonstrating an efficient approach to enhance the efficiency of frequency modulation of lower frequency signals.

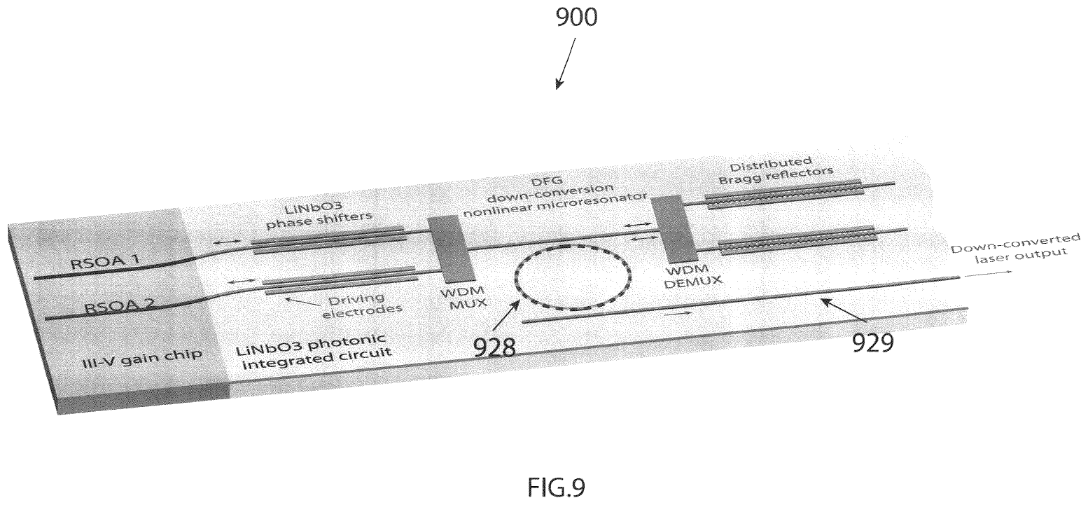

FIG. 9 schematically illustrates another embodiment 900 similar to FIG. 7 except that the DFG waveguide 728 is replaced by a DFG nonlinear microresonator 928 and the down-converted light at frequency ωₛ is coupled output with waveguide 929.

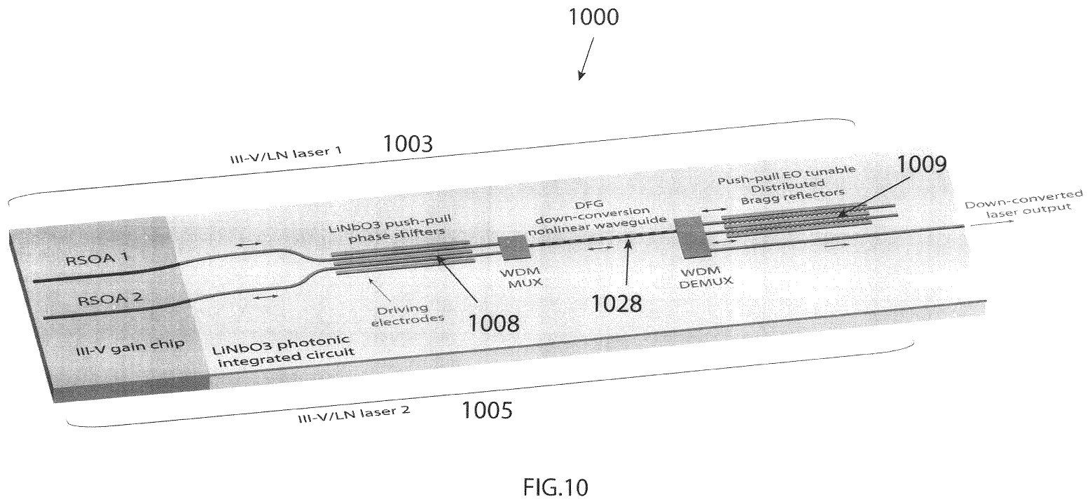

Another embodiment emanating from that shown with reference to FIG. 7 is the EOM 1000 schematically illustrated in FIG. 10, where the two lasers 1003, 1005 are electro-optically modulated with simple push-pull phase modulators 1008, as well as with push-pull modulated DBRs, 1009, as shown. This configuration will automatically produce opposite frequency tuning of the two lasers.

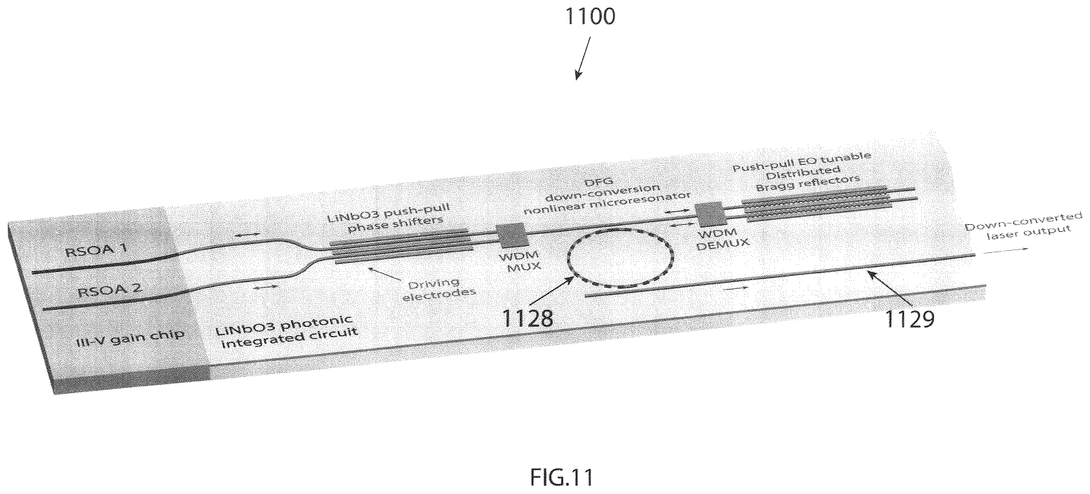

Similarly, the intracavity DFG nonlinear waveguide 1028 in FIG. 10 can be replaced with a DFG nonlinear microresonator 1128, and the down-converted light at frequency ωₛ is coupled output with waveguide 1129, as shown in the EOM 1100 in FIG. 11.

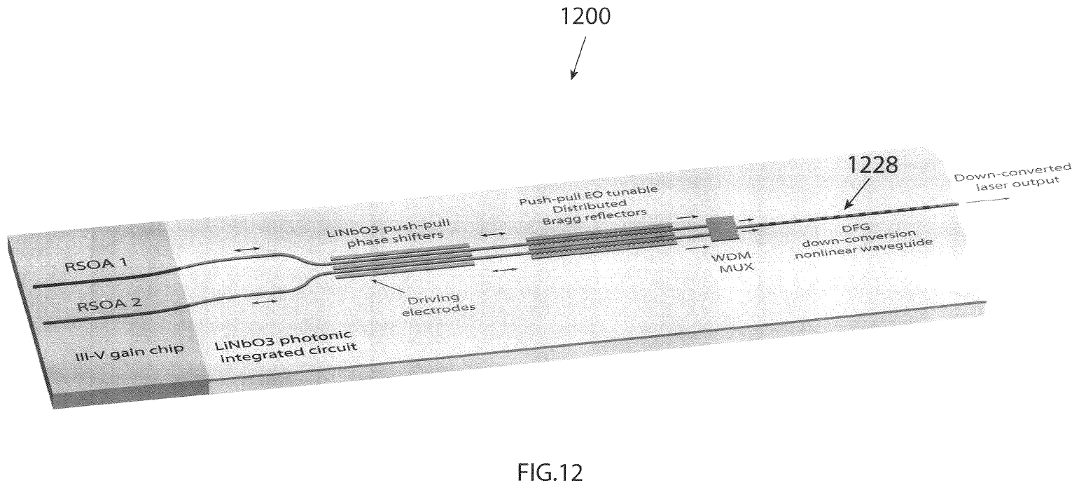

FIG. 12 schematically illustrates an EOM device 1200 similar to that in FIG. 10 except that the DFG nonlinear waveguide 1228 is placed outside the laser cavity.

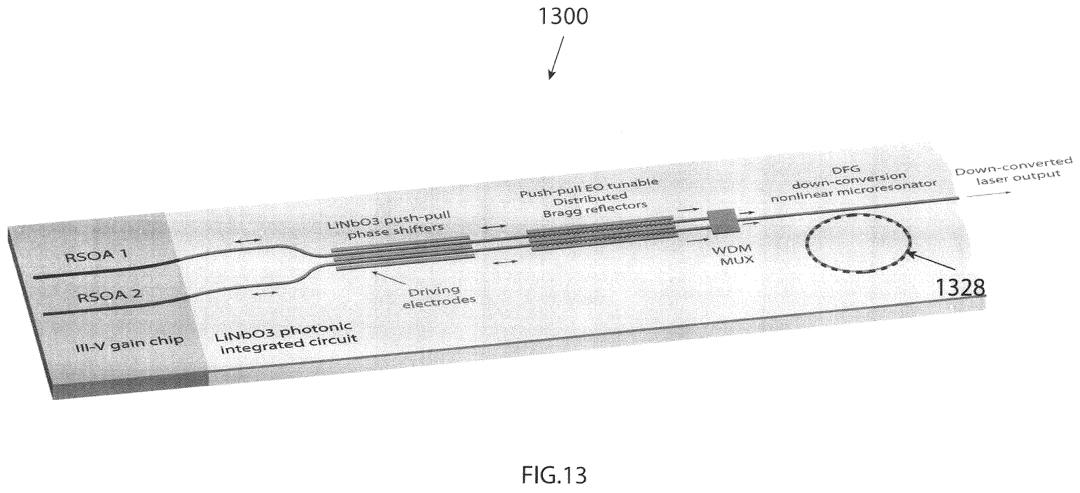

FIG. 13 shows an EOM device 1300 similar to FIG. 12 except that the DFG nonlinear waveguide 1228 is replaced with a DFG nonlinear microresonator 1329.

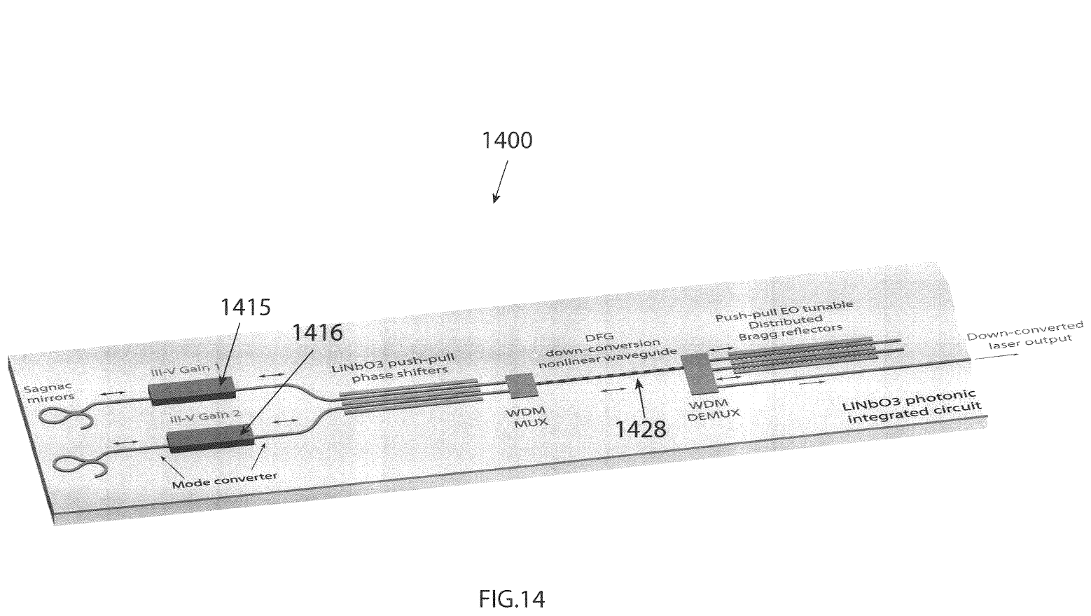

FIG. 14 schematically illustrates a similar concept EOM 1400 in which the III-V gain elements 1415 and 1416 are heterogeneously integrated on the top of the LN waveguide structure, as opposed to edge coupling as schematically shown in FIGS. 1-13 (where the III-V gain element is shown as a reflective semiconductor optical amplifier (RSOA)).

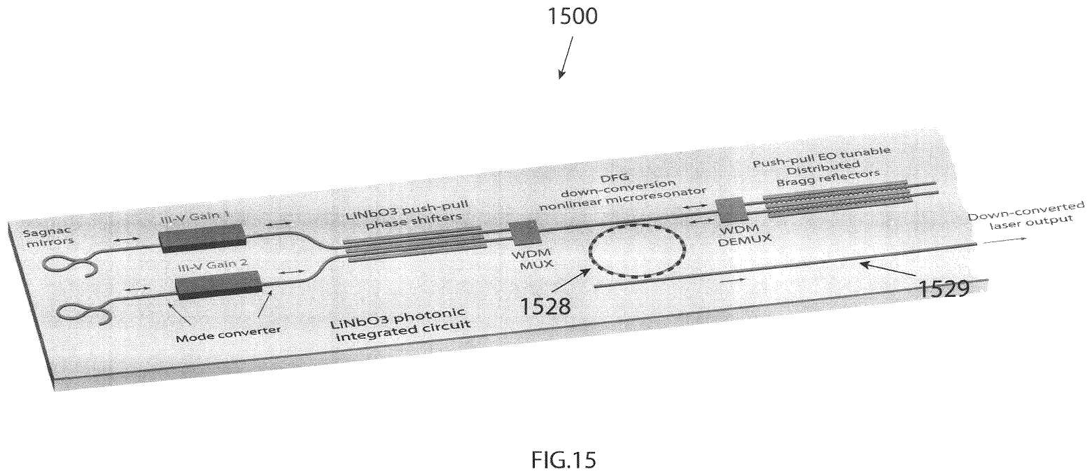

FIG. 15 shows an EOM device 1500 similar to FIG. 14 except that the DFG nonlinear waveguide 1428 is replaced by a DFG nonlinear microresonator 1528, and the down-converted light is coupled out with a coupling waveguide 1529.

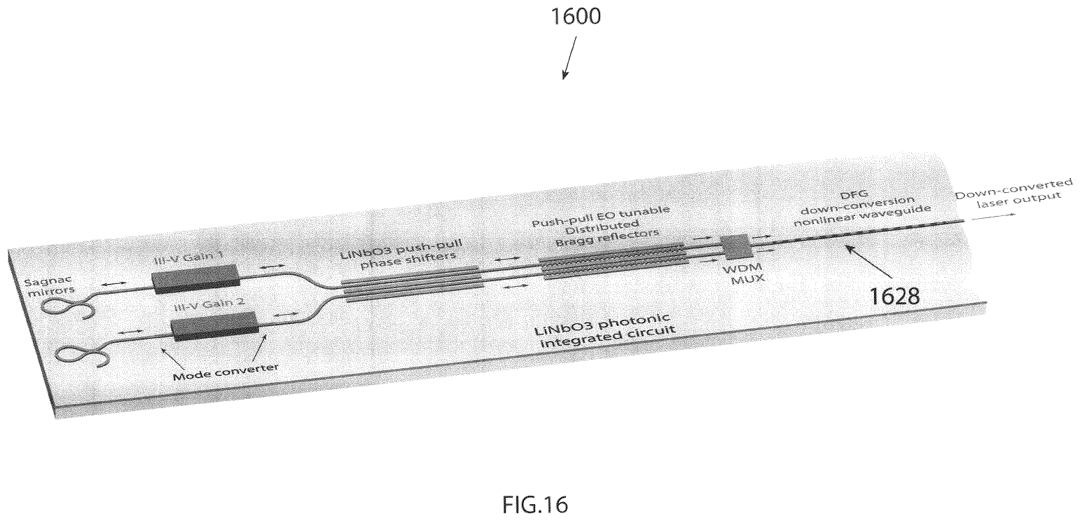

FIG. 16 shows an EOM device 1600 similar to FIG. 14 except that the DFG nonlinear waveguide 1628 is placed outside the laser cavity.

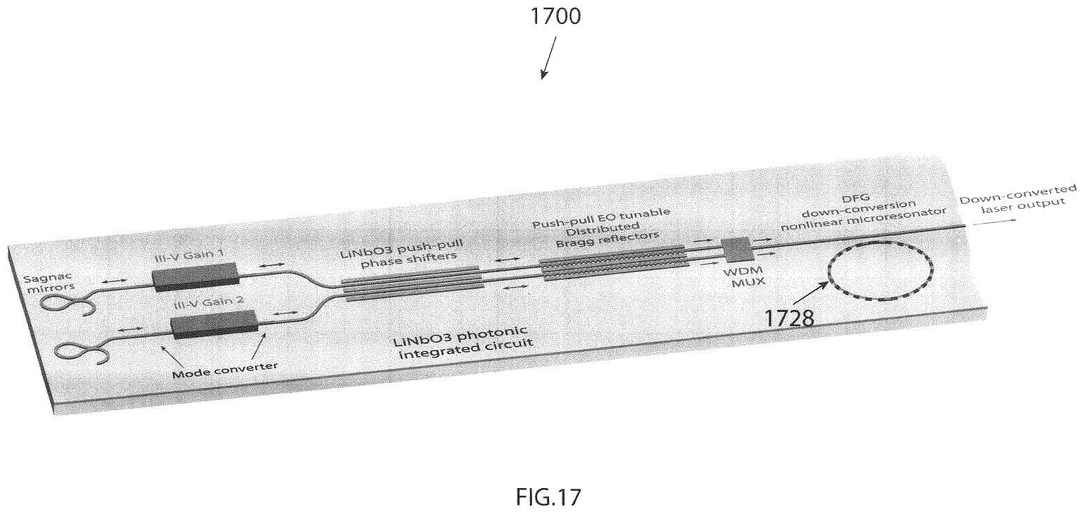

FIG. 17 shows an EOM device 1700 similar to FIG. 16 except that the DFG nonlinear waveguide 1628 is replaced by a DFG nonlinear microresonator 1728.

Moreover, laser 1 and laser 2 used for DFG are generally not fully depleted and some residual waves of the two lasers will output for the DFG nonlinear waveguide or the DFG nonlinear microresonator. Therefore, the invented approach can produce multiple frequency-modulated lasing waves at the same time if laser 1 and laser 2 are also coupled out of the device.

Notwithstanding that the numerical ranges and parameters setting forth the broad scope of the disclosed embodiments are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5.

While various disclosed embodiments have been described above, it should be understood that they have been presented by way of example only and not as a limitation. Numerous changes to the disclosed embodiments can be made in accordance with the specification herein without departing from the spirit or scope of this specification. Thus the breadth and scope of this specification should not be limited by any of the above-described embodiments; rather, the scope of this specification should be defined in accordance with the appended claims and their equivalents.

I claim:

1. An electro-optic modulator device, comprising:
a device platform adapted to functionally support at least one of the following components:
an input propagation path for a first laser at frequency, ω₁;
an input propagation path for a second laser at frequency, ω₂;
an electro-optic modulator (EOM) adapted to modulate the wave at ω₁ via an input control signal;
a wavelength division multiplexer (WDM MUX) adapted to combine the two optical waves at ω₁ and ω₂;
a difference frequency generator (DFG) adapted to down-convert the combined waves at ω₁ and ω₂ to a wave at a third frequency, ωₛ, where ωₛ=|ω₁−ω₂|, further wherein ωₛ is less than ω₂ and ω₁,
whereby an output from the device at ωₛ is a modulated signal having a modulation efficiency comparable to a modulation efficiency of the wave at ω₁.

2. The electro-optic modulator device of claim 1, further comprising a wavelength division demultiplexer (WDM DEMUX) adapted to separate two launched inputs at ω₁ and ω₂ into the input propagation path for the first laser at frequency, ω₁, and the input propagation path for the second laser at frequency, ω₂, respectively.

3. The electro-optic modulator device of claim 1, wherein the device platform is one of a lithium niobate (LiNbO₃), lithium tantalate (LiTaO₃), potassium niobate (KNbO₃), III-V semiconductors (AlN, GaN, GaP, GaAs, AlGaAs, InP), barium titanate (BaTiO₃), electro-optic polymer, silicon, or a composite medium formed by integrating one of these materials with a dielectric material such as silicon nitride or silicon dioxide.

4. The electro-optic modulator device of claim 1, wherein the EOM is made from the device platform material.

5. The electro-optic modulator device of claim 1, wherein the DFG is one of a DFG nonlinear waveguide and a DFG nonlinear microresonator.

6. The electro-optic modulator device of claim 5, further comprising an input laser source for ω₁ and ω₂ integrally disposed on the device platform.

7. The electro-optic modulator device of claim 6, wherein the input laser source comprises:
a first laser operating at frequency ω₁ formed by an external cavity on the device platform and a III-V gain element, an electro-optically or thermo-optically tunable distributed Bragg reflector (DBR) operating at frequency ω₁, an electro-optic or thermo-optic phase shifter, and a III-V reflective semiconductor optical amplifier (RSOA) having a gain spectrum covering ω₁; and
a second laser operating at frequency ω₂ formed by an external cavity on the device platform and a III-V gain element, an electro-optically or thermo-optically tunable distributed Bragg reflector (DBR) operating at frequency ω₂, an electro-optic or thermo-optic phase shifter, and a III-V reflective semiconductor optical amplifier (RSOA) having a gain spectrum covering ω₂.

8. The electro-optic modulator device of claim 6, wherein the DFG device is physically disposed in the laser cavity.

9. The electro-optic modulator device of claim 6, wherein the EOM is a push-pull phase modulator.

10. The electro-optic modulator device of claim 6, wherein the DBR is push-pull modulated DBR structure.

11. The electro-optic modulator device of claim 1, wherein the input laser source is edge-coupled to the device platform.

12. The electro-optic modulator device of claim 7, wherein the input laser source is heterogeneously integrated on a surface of the device platform.

13. An electro-optic (EO) modulation method, comprising:
providing a first propagating EM wave having a frequency, ω₁;
providing a second propagating EM wave having a frequency, ω₂;
modulating the EM wave at frequency ω₁;
combining the first and second propagating EM waves,
employing a difference frequency generation (DFG) process on the combined EM waves to generate a down-converted EM wave ωₛ=|ω₁−ω₂|, where ωₛ is less than ω₂ and ω₁,
whereby a high modulation efficiency at the higher frequency ω₁ is directly transferred to the lower frequency at ωₛ.

14. The method of claim 13, further comprising modulating the wave at ω₂.

15. The method of claim 13, further comprising modulating the wave at ω₁ with a ramp rate η₁ greater than zero and modulating the wave at ω₂ with an opposite ramp rate η₂ less than zero, or vice versa,
whereby a ramp rate of the down-converted wave at ω₃ is the sum of the ramp rates for ω₁ and ω₂, such that |η₃|=|η₁|+|η₂|.
